(19) United States
(12) Patent Application Publication
(10) Pub. No.: US 2006/0256367 A1
(43) Pub. Date: Nov. 16, 2006

(54) Approach for troubleshooting errors on printing devices

(76) Inventor: Ke Wei, San Jose, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/129,097

(22) Filed: May 13, 2005

(51) Int. Cl. G06F 3/12; G06F 15/00

(52) U.S. Cl. 358/1.15; 358/1.9; 358/504

(57) ABSTRACT

An approach is provided for troubleshooting printing devices. A printing device is configured to generate error report data when an error prevents print data from being successfully processed on the printing device. The error report data includes error data that indicates attributes of the error that occurred and configuration data that indicates configuration attributes of the printing device. The printing device may be configured to provide the error report data in a secure manner over a network to a network device. The error report data may include at least a portion of the print data that could not be successfully processed because of the error. Other types of data besides print data may also be included in the error report data, such as scan data, facsimile data, or any combination thereof. Data compression may also be used to reduce the size of the error report data.

### FIELD OF THE INVENTION

This invention relates generally to printing devices, and more specifically, to an approach for troubleshooting errors on printing devices.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

The proliferation of computer technology and the growth of the Internet have greatly increased access to electronic information. Printing technology has also seen tremendous advancement. It is not uncommon for printing devices to include multiple other functions besides printing, such as scanning, copying and faxing. These types of printing device are often referred to as multi-function peripherals (MFPs). MFPs are often configured with one or more network interfaces, have large amounts of memory to support many print jobs and users and have sophisticated user interfaces.

One of the issues with printing devices, is that with their sophisticated and diverse functionality, it can be difficult to diagnose and fix problems. Many printing devices include error diagnostic functions that provide information about errors that have occurred. The diagnostic information is typically provided to a service engineer via a display panel or screen on the printing device or via one or more printed pages. The error diagnostic information typically includes details about an error to assist a service engineer in determining the source of an error.

One of the issues with this conventional approach for troubleshooting printing devices is that it requires that the service engineer be present at the printing device to receive the error diagnostic information. Thus, a service engineer cannot diagnose and address errors remotely. Furthermore, even if complete error report data is made available to a service engineer at a remote location, for example by another person faxing an error report page to the service engineer, the service engineer may not be able to fully address the problem without being able to reproduce the error. Even if the service engineer has the identical printing device at their location and complete information about the error that occurred, the service engineer may not be able to solve the problem unless the service engineer can reproduce the error. Some errors cannot be accurately reproduced unless the service engineer has the exact print data that was being processed by the printing device at the time the error occurred. This is typically not possible because either the print data that was being processed at the time the error occurred has been either discarded or maintained at the printing device and is therefore unavailable to the service engineer. Thus, the service engineer is left to attempt to reproduce an error without the actual print data that was being processed when the error occurred, which is less than ideal. Based on the foregoing, there is a need for an approach for troubleshooting errors on printing devices that does not suffer from limitations of prior approaches.

### SUMMARY

An approach is provided for troubleshooting printing devices. A printing device is configured to generate error report data when an error prevents print data from being successfully processed on the printing device. The error report data includes error data that indicates attributes of the error that occurred and configuration data that indicates configuration attributes of the printing device. According to one embodiment of the invention, the printing device is further configured to provide the error report data in a secure manner over a network to a network device. This may include, for example, encrypting the error report data or using a secure communications link. According to another embodiment of the invention, the error report data includes at least a portion of the print data that could not be successfully processed because of the error. Other types of data besides print data may also be included in the error report data. For example, the error report data may include at least a portion of scan data or facsimile data, or any combination of print data, scan data and facsimile data, that could not be successfully processed at the printing device because of an error. Data compression may also be used to reduce the size of the error report data.

The approach allows service engineers and other interested parties to more effectively diagnose, from remote locations, errors that occur on printing devices. The error report data provides information about the error that occurred and the configuration of the printing device. The error report data may also include data, such as print data, that could not be successfully processed because of the error. This allows a service engineer to better reproduce the exact conditions that existed when the error occurred.

### BRIEF DESCRIPTION OF THE DRAWINGS

In the figures of the accompanying drawings like reference numerals refer to similar elements.

FIG. 1 is a block diagram that depicts an arrangement for troubleshooting printing devices according to one embodiment of the invention.

FIG. 2 is a block diagram that depicts example contents of a error report data, according to an embodiment of the invention.

FIG. 3 is a block diagram that depicts an example data format for error report data, according to an embodiment of the invention.

FIG. 4 is a block diagram that depicts example functional modules contained in an error manager, according to an embodiment of the invention.

FIG. 5 is a flow diagram that depicts an approach for troubleshooting a printing device according to one embodiment of the invention.

FIG. 6 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. ARCHITECTURE
III. GENERATING ERROR REPORT DATA
IV. PROVIDING ERROR REPORT DATA TO OTHER ENTITIES
V. OPERATIONAL EXAMPLE
VI. IMPLEMENTATION MECHANISMS
   I. Overview

An approach is provided for troubleshooting printing devices. A printing device is configured to generate error report data when an error prevents print data from being successfully processed on the printing device. The error report data includes error data that indicates attributes of the error that occurred and configuration data that indicates configuration attributes of the printing device. According to one embodiment of the invention, the printing device is further configured to provide the error report data in a secure manner over a network to a network device. This may include, for example, encrypting the error report data or using a secure communications link. According to another embodiment of the invention, the error report data includes at least a portion of the print data that could not be successfully processed because of the error. Other types of data besides print data may also be included in the error report data. For example, the error report data may include at least a portion of scan data or facsimile data, or any combination of print data, scan data and facsimile data, that could not be successfully processed at the printing device because of an error. Data compression may also be used to reduce the size of the error report data.

The approach allows service engineers and other interested parties to more effectively diagnose, from remote locations, errors that occur on printing devices. The error report data provides information about the error that occurred and the configuration of the printing device. The error report data may also include data, such as print data, that could not be successfully processed because of the error. This allows a service engineer to better reproduce the exact conditions that existed when the error occurred.

II. Architecture

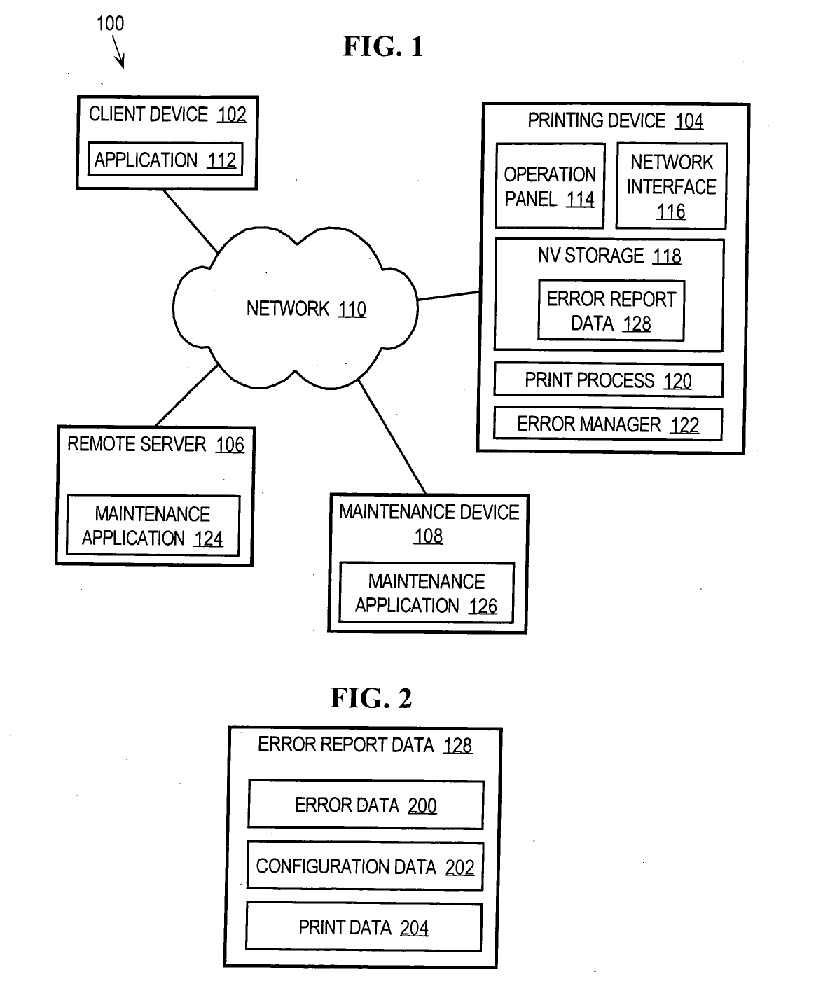

FIG. 1 is a block diagram that depicts an arrangement 100 for troubleshooting printing devices according to one embodiment of the invention. Arrangement 100 includes a client device 102, a printing device 104, a remote server 106 and a maintenance device 108 that are communicatively coupled via a network 110. Network 110 may be implemented by any medium or mechanism that provides for the exchange of data between client device 102, printing device 104, remote server 106 and maintenance device 108. Examples of network 110 include, without limitation, a network such as a Local Area Network (LAN), Wide Area Network (WAN), Ethernet or the Internet, or one or more terrestrial, satellite or wireless links. Portions of network 110 may be wired connections, while other portions may be wireless connections, depending upon a particular implementation. For example, the connection between remote server 106 and network 110 may be a wired connection, while the connection between maintenance device 108 and network 110 is a wireless connection.

Client device 102 may be any type of client device. Examples of client device 102 include, without limitation, a workstation, a personal computer, a Personal Digital Assistant (PDA), any type of mobile device and a cellular telephone. Client device 102 is configured with an application 112 that may be any process capable of generating print data. Examples of application 112 include, without limitation, a word processor, a spreadsheet program, an email client, a generic Web browser, a photo management program and a drawing or computer-aided design (CAD) program. Client device 102 may include other elements and processes that are not depicted in FIG. 1 and described here for purposes of explanation. For example, client device 102 typically includes a wired or wireless network interface that allows client device 102 to connect to network 110.

Printing device 104 may be any device capable of printing electronic documents. Examples of printing device 104 include, without limitation, a printer, a copier, a facsimile and an MFP. According to one embodiment of the invention, printing device 104 includes an operation panel 114, a network interface 116, a Non-Volatile (NV) storage 118, a print process 120 and an error manager 122. Printing device 104 may be configured with fewer or more components and processes, depending upon a particular implementation, and the invention is not limited to the example depicted in FIG. 1 and described herein.

Operation panel 114 is a mechanism and/or process that allows the exchange of information between printing device 104 and a user. For example, operation panel 114 may include a display for conveying information to a user and a touchpad, buttons, or touch screen for receiving user input.

Network interface 116 is an interface that allows printing device to be communicatively coupled to network 110. Examples of network interface 116 include, without limitation, a wired interface, such as an Ethernet card, and a wireless interface, such as an 802.x card. NV storage 118 may be any type of non-volatile storage. Examples of NV storage 118 include, without limitation, non-volatile memory, such as a flash memory, an optical storage device, an electro-optical storage device and one or more hard disks. Print process 120 is a process configured to process print data and generate printed versions of electronic documents. Error manager 122 is a mechanism or process configured to assist in troubleshooting errors that occur on printing device 104, as described in more detail hereinafter. Error manager 122 may be implemented as an application process executing on printing device 104, or as a layer between an operating system and applications executing on printing device 104.

Remote server 106 is a repository for error report data received from printing device 104. Remote server 106 may store error report data from any number of printing devices and make the data available to service engineer personnel diagnosing errors on those printing devices. Remote server 106 may be configured with a maintenance application 124 for managing and providing access to error report data stored on remote server 106.

Maintenance device 108 is a device that may be used by a service engineer to diagnose errors on printing device 104. Maintenance device 108 may be any type of device, depending upon the particular implementation. Examples of maintenance device 108 include, without limitation, a workstation, a personal computer, a Personal Digital Assistant (PDA), any type of mobile device and a cellular telephone. According to one embodiment of the invention, maintenance device 108 is configured with a maintenance application 126 that assists a service engineer in diagnosing errors on printing device 104. For example, maintenance application 126 may be configured to allow a service engineer to view error report data received from printing device 104 or error report data stored on remote server 106. Examples of maintenance application 126 include, without limitation, an email client, a generic Web browser and any other type of program.

III. Generating Error Report Data

Printing device 104 is configured to generate error report data 128. As depicted in FIG. 1 and described herein for purposes of explanation, error report data 128 is stored on NV storage 118, but may be stored elsewhere, depending upon a particular implementation. According to one embodiment of the invention, error report data 128 is generated by error manager 122 in response to detecting that an error has prevented print data from being completely processed. For example, suppose that a user uses application 112 to generate an electronic document and -then print the electronic document to printing device 104. Application 112 generates print data that is transmitted to printing device 104 over network 110. Printing device 104 receives the print data and print process 120 processes the print data. In the event an error prevents the print data from being processed successfully, error manager 122 generates error report data 128. Many different types of errors may prevent the successful processing of print data on printing device 104. For example, lack of consumables, such as toner or paper, may prevent the successful processing of print data. As another example, a mechanical failure may prevent the successful processing of print data. As yet another example, an electrical or computer failure, such as a bad chip or other component, may prevent the successful processing of print data. As a further example, a failure in print process 120 or another process executing on printing device 104, may prevent the successful processing of the print data.

Error report data 128 may include a wide variety of information, depending upon a particular implementation, and the invention is not limited to error report data 128 containing any particular information. For example, as depicted in FIG. 2, error report data 128 may include error data 200, configuration data 202, print data 204, or any combination thereof. Error data 200 is data that indicates one or more attributes of the error that occurred. For example, error data 200 may specify the particulars of an error that occurred, such as an error number, code and/or description. Some printing devices use error coding schemes that associate error codes with particular errors to allow service engineers to quickly diagnose an error. Error data 200 may also include data that indicates when an error occurred, such as a timestamp.

Configuration data 202 is data that indicates one or more attributes of the configuration of printing device 104. Example configuration data 202 indicates, without limitation, the model and serial number of printing device 104, installed printing and finishing options, any installed hardware and software including interfaces, versions of installed hardware, software or firmware, current protocols, ports and applications, current status of any component or element of printing device 104. Configuration data 202 may also indicate any changes in configuration that occurred over time.

Print data 204 may include any portion or all of print data received from client device 102. For example, print data 204 may include a portion of print data that was being processed when an error occurred. Error report data 128 may reflect any number of errors. For example, error report data 128 may reflect a number of errors that occurred over a specified time. In this situation, error report data 128 may include separate error data 200 and print data 204 for each error. Error report data 128 may indicate the entity that provide each set of print data to printing device 104. The entities may be identified, for example, by IP address, or other identifier information. Error report data 128 may also include the details of a request sent to printing device 104. For example, error report data 128 may include a Simple Network Management Protocol (SNMP) request sent to printing device 104 for print data to be processed. Error report data 128 may also include other logs or history information generated by printing device 104.

Error report data 128 may be in a variety of formats, depending upon a particular implementation, and the invention is not limited to error report data 128 being in any particular format. Example formats for error report data 128 include, without limitation, plain text, ASCII, rich text format, encoded text, text with layout, text that conforms to the format of a particular word processor, such as Microsoft Word format, hyper text markup language (HTML), formatted text and XML. Error report data 128 may be formatted as plain data, as a message, an email message, a word processing document, or any other format used by a recipient. File Transfer Protocol (FTP) may also be used to provide error report data 128 to a recipient, such as remote server 106.

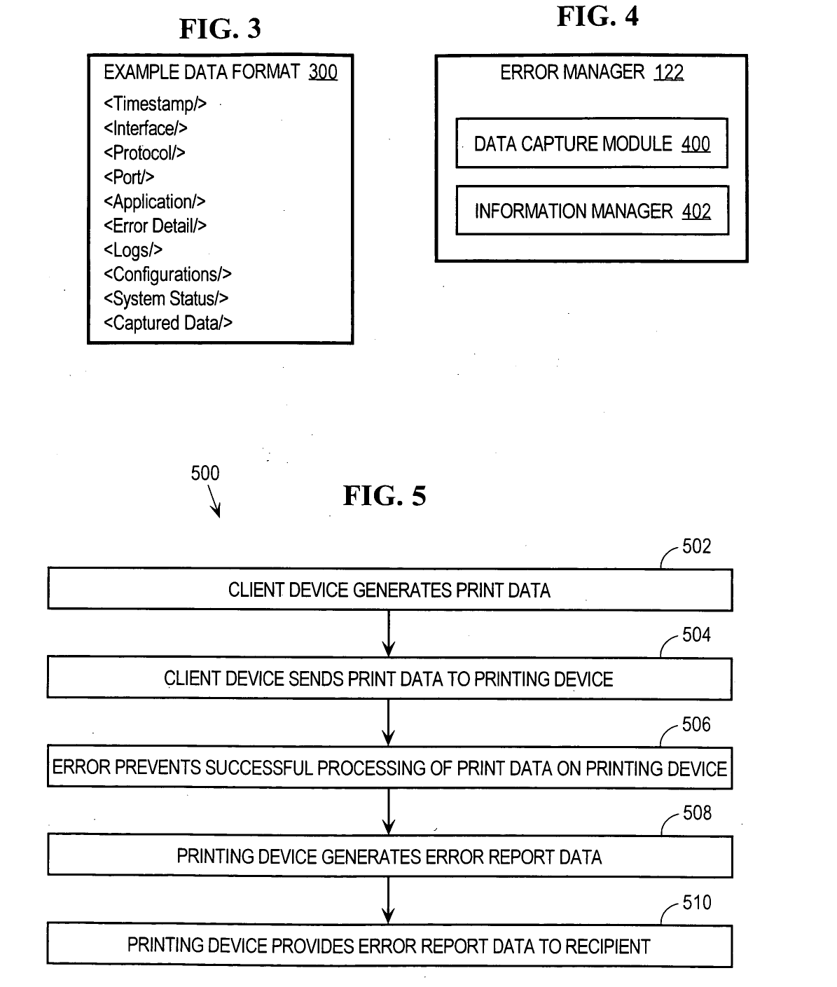

FIG. 3 is a block diagram that depicts an example data format 300 for error report data 128, according to one embodiment of the invention. The invention is not limited to any particular format and the data format 300 depicted in FIG. 3 is one example format that may vary depending upon a particular implementation. In the example depicted in FIG. 3, the data format 300 includes a timestamp that indicates a date and time when the data was captured. Data format 300 also includes attributes of network interface 116, as well as the protocol and port used. Data format 300 also specifies the application being used on printing device 104, e.g., printing, scanning, copying, etc. Data format 300 also indicates error detail, logs, configurations, system status and captured print data 204.

Error manager 122 may be implemented by any mechanism or process for performing the functionality described herein. According to one embodiment of the invention, as depicted in FIG. 4, error manager 122 includes a data capture module 400 and an information manager 402. Data capture module 400 is configured to capture portions or entire print data received from client device 102 for inclusion in inclusion in error report data 128 as print data 204. For example, suppose that client device 102 submits several sets of print data to printing device 104 for processing, where each set of print data represents an electronic document. Data capture module 400 is configured to capture any portions of the several sets of print data. Data capture module 400 may also capture data included in error data 200. Information manager 402 is configured to provide other information for error report data 128, such as configuration data 202.

IV. Providing Error Report Data to Other Entities

According to one embodiment of the invention, printing device 104 is configured to report error report data to other entities. The particular entities to which printing device reports the error report data and the manner in which the error report data is reported to those entities may vary depending upon a particular implementation and the invention is not limited to any particular type of receiving entity or manner of reporting the error report data.

Error manager 122 may be configured to provide error report data 128 to entities, such as remote server 106, at specified times, for example, based upon a schedule. In this situation, error manager 122 generates error report data 128 that reflects the error history over time for printing device 104. Error manager 122 may also be configured to provide error report data 128 to entities after an error occurs. For example, in response to the occurrence of an error and the generation of error report data 128, printing device 104 automatically sends error report data 128 to maintenance device 108. Error manager 122 may further be configured to provide error report data 128 to entities in response to requests from those entities. For example, a user of maintenance device 108 makes a query for any errors on printing device 104 as part of a health check. Maintenance device 108 generates a request and provides the request to printing device 104. In response to receiving the request, printing device 104 provides error report data 128 to maintenance device 108. Error report data 128 may reflect any number of errors and therefore can provide a complete error history for a service engineer.

As previously mentioned herein, error report data 128 may be provided to an entity in a secure manner. For example, error report data 128 may be provided to maintenance device 108 using a secure communications link, such as a virtual private network (VPN). As another example, error report data 128 may be encrypted. The encryption may be done using a variety of techniques, depending upon a particular implementation. For example, error report data 128 may be encrypted using a proprietary algorithm or key known to printing device 104 and maintenance device 108. The algorithm or key may be specified in the configuration of printing device 104. As another example, error report data 128 may be encrypted using any of the well-known public key encryption techniques.

According to one embodiment of the invention, error report data 128 is compressed to reduce the amount of data that is transmitted to another entity, such as maintenance device 108. Any type of compression technique may be used, depending upon the requirements of a particular implementation, and the invention is not limited to any particular compression technique. For example, any well-known compression technique may be used. This may be useful in situations where error report data 128 reflects many errors or large amounts of print data.

V. Operational Example

FIG. 5 is a flow diagram 500 that depicts an approach for troubleshooting a printing device according to one embodiment of the invention. In step 502, client device 102 generates print data. For example, a user of client device 102 uses application 112, in this example a word processor, to generate an electronic document. The user then selects a print option in the word processor. In response to the user selecting the print option, the word processor generates print data, for example in Page Definition Language (PDL) format.

In step 504, client device 102 sends the print data to printing device 104. In the present example, the word processor includes configuration data that specifies printing device 104 as the destination for the print data. Printing device 104 typically stores the print data in a volatile memory, such as a Random Access Memory (RAM).

In step 506, an error prevents the successful processing of the print data on printing device 104. For example, a mechanical, electrical, software, firmware or hardware error, or a lack of consumables, such as paper, toner, staples, etc., prevents the print data from being successfully processed on printing device 104.

In step 508, printing device 104 generates error report data 128 in response to the unsuccessful processing of the print data on printing device 104.

In step 510, printing device 104 provides the error report data 128 to maintenance device 108. For example, error manager 122 may automatically send the error report data 128 to maintenance device 108. Error manager 122 may also send a notification, such as an email, cell phone page, etc., to notify a service engineer that an error has occurred. The notification and error report data 128 may be combined or sent separately. The error report data 128 may be sent to printing device 104 in a secure manner or compressed, as previously described herein. The error report data 128 may be stored on maintenance device 108, for example, in a RAM or non-volatile storage. The service engineer accesses the error report data 128 on maintenance device 108 and diagnoses the error.

VI. Implementation Mechanisms

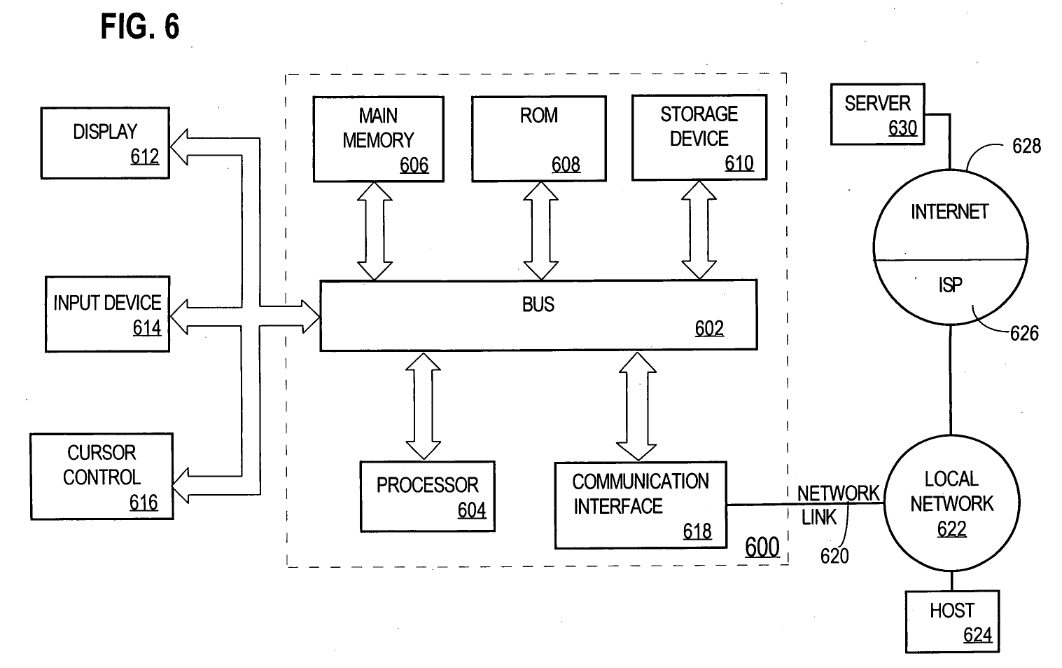

Although primarily described herein in the context of troubleshooting errors on printing devices, the approach is applicable to any type of network device or element. The approach described herein and the various elements, such as error manager 122, may be implemented in hardware, computer software or any combination of hardware and computer software on any type of computing platform. FIG. 6 is a block diagram that illustrates an example computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 600, various machine-readable media are involved, for example, in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infrared data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector can receive the data carried in the infrared signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A printing device comprising:
a print process configured to process print data and cause a printed version of an electronic document to be generated at the printing device; and
wherein the printing device is configured to
in response to an error that prevents the processing of the print data to be completed successfully on the printing device,
generate error report data that includes at least a portion of the print data, and
provide the error report data over a network to a network device.

2. The printing device as recited in claim 1, wherein the error report data indicates one or more attributes of the error and one or more configuration attributes of the printing device.

3. The printing device as recited in claim 1, wherein the printing device is further configured to provide the error report data over the network to the network device using a secure communications protocol.

4. The printing device as recited in claim 1, wherein the printing device is further configured to encrypt the error report data before providing the error report data over the network to the network device.

5. The printing device as recited in claim 1, wherein:
the network device is a wireless network device; and
the printing device is further configured to provide the error report data over a wireless communications link to the wireless network device.

6. The printing device as recited in claim 1, wherein the printing device is further configured to compress the error report data before providing the error report data to the network device over the network.

7. A printing device comprising:
a print process configured to process print data and cause a printed version of an electronic document to be generated; and
wherein the printing device is configured to
in response to an error that prevents the processing of the print data to be completed successfully,
generate error report data,
generate encrypted error report data by encrypting the error report data, and
provide the encrypted error report data over a network to a network device.

8. The printing device as recited in claim 7, wherein the error report data indicates one or more attributes of the error and one or more configuration attributes of the printing device.

9. The printing device as recited in claim 7, wherein the printing device is further configured to provide the error report data over the network to the network device using a secure communications protocol.

10. The printing device as recited in claim 7, wherein the printing device is further configured to encrypt the error report data before providing the error report data over the network to the network device.

11. The printing device as recited in claim 7, wherein:
the network device is a wireless network device; and
the printing device is further configured to provide the error report data over a wireless communications link to the wireless network device.

12. The printing device as recited in claim 7, wherein the printing device is further configured to compress the error report data.
